(19) United States
(12) Patent Application Publication
(10) Pub. No.: US 2015/0037613 A1
(43) Pub. Date: Feb. 5, 2015

(54) MAGNETIC DEVICES WITH OVERCOATS

(71) Applicant: SEAGATE TECHNOLOGY LLC, Cupertino, CA (US)

(72) Inventors: Nils Gokemeijer, Edina, MN (US); Tong Zhao, Eden Prairie, MN (US); James Kiely, Edina, MN (US)

(73) Assignee: SEAGATE TECHNOLOGY LLC, Cupertino, CA (US)

(21) Appl. No.: 13/953,788

(22) Filed: Jul. 30, 2013

(51) Int. Cl. G11B 5/40; G11B 5/84

(52) U.S. Cl. CPC G11B 5/40; G11B 5/8408
USPC 428/814; 427/127

(57) ABSTRACT

A magnetic device including a magnetic writer; and an overcoat positioned over at least the magnetic writer, the overcoat including tantalum oxide (Ta_{y}Oₓ), where y ranges from about 1 to 2 and x ranges from about 2 to 5, or mixtures thereof.

### BACKGROUND

The heat assisted magnetic recording (HAMR) process can involve an environment that can be extremely corrosive because of the high temperature and exposure to corrosive chemistries. Furthermore, designs using close head-media spacing will experience more rapid wear of any narrow, protruded features such as write poles. Because of the harsh environment and the desire to protect some of the more delicate structures, for example the near field transducer (NFT) and the write pole for example; there remains a need for different types of overcoats.

### SUMMARY

A magnetic device including a magnetic writer; and an overcoat positioned over at least the magnetic writer, the overcoat including tantalum oxide (Ta_{y}Oₓ), where y ranges from about 1 to 2 and x ranges from about 2 to 5, or mixtures thereof.

A method of forming an article, the method including forming a magnetic structure on a substrate, the magnetic structure having a first surface adjacent the substrate and a second opposing surface; and forming a tantalum oxide layer on the second surface of at least the magnetic structure.

A method of forming an article, the method including forming a magnetic structure on a substrate; forming a tantalum layer on at least the magnetic structure; and oxidizing at least a portion of the tantalum layer to form a tantalum oxide layer.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE FIGURES

FIG. 1 is a pictorial representation of a data storage device in the form of a disc drive that can include a recording head constructed in accordance with an aspect of this disclosure.

FIG. 2 is a side elevation view of a recording head constructed in accordance with an aspect of the invention.

FIG. 3 is a schematic depiction of a device, looking from the air bearing surface (ABS).

FIG. 4 shows the electrical resistance of a sheet (Ω/square) of tantalum after deposition (growth) of the tantalum for a tantalum sheet in air and a tantalum sheet that is oxygen ashed.

FIG. 5 shows a plot of current (pA) versus applied bias (V) for oxygen ashed tantalum.

FIG. 6 is a mapping of the leakage current under a 2V bias within a 5 um×5 um region.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

In the following description, reference is made to the accompanying set of drawings that form a part hereof and in which are shown by way of illustration several specific embodiments. It is to be understood that other embodiments are contemplated and may be made without departing from the scope or spirit of the present disclosure. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

“Include,” “including,” or like terms means encompassing but not limited to, that is, including and not exclusive. It should be noted that “top” and “bottom” (or other terms like “upper” and “lower”) are utilized strictly for relative descriptions and do not imply any overall orientation of the article in which the described element is located.

Disclosed overcoats can advantageously provide devices that may be more robust in high temperature environments, such as HAMR. Disclosed methods of making such overcoats are also provided herein.

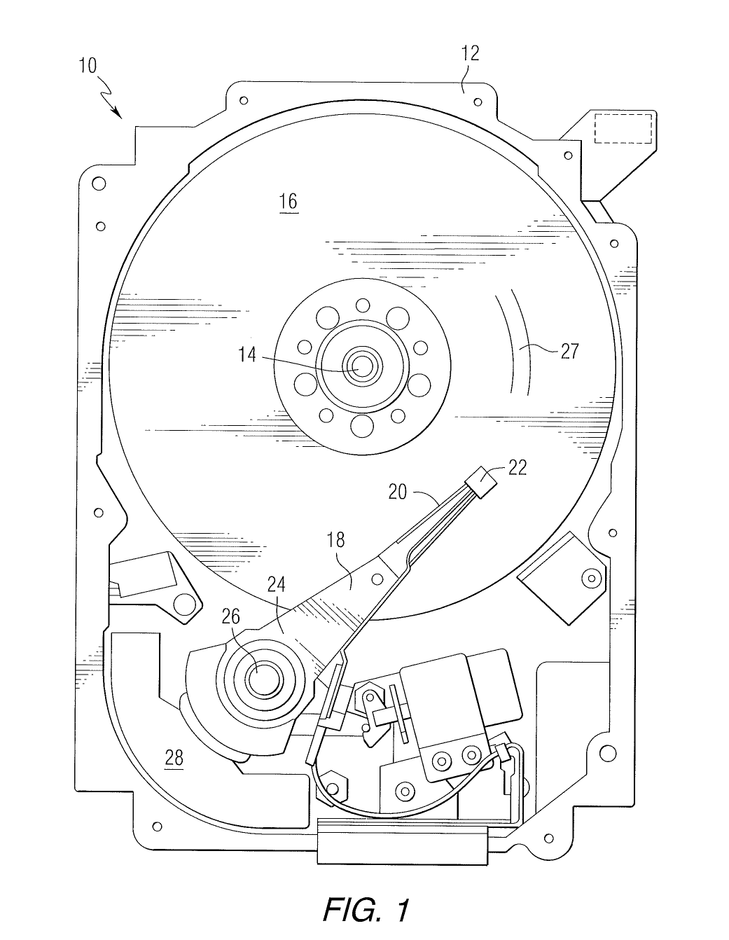

Disclosed herein are NFTs and devices that include such NFTs. FIG. 1 is a pictorial representation of a data storage device in the form of a disc drive 10 that can utilize disclosed NFTs. The disc drive 10 includes a housing 12 (with the upper portion removed and the lower portion visible in this view) sized and configured to contain the various components of the disc drive. The disc drive 10 includes a spindle motor 14 for rotating at least one magnetic storage media 16 within the housing. At least one arm 18 is contained within the housing 12, with each arm 18 having a first end 20 with a recording head or slider 22, and a second end 24 pivotally mounted on a shaft by a bearing 26. An actuator motor 28 is located at the arm's second end 24 for pivoting the arm 18 to position the recording head 22 over a desired sector or track 27 of the disc 16. The actuator motor 28 is regulated by a controller, which is not shown in this view and is well-known in the art. The storage media may include, for example, continuous media or bit patterned media.

For heat assisted magnetic recording (HAMR), electromagnetic radiation, for example, visible, infrared or ultraviolet light is directed onto a surface of the data storage media to raise the temperature of a localized area of the media to facilitate switching of the magnetization of the area. Recent designs of HAMR recording heads include a thin film waveguide on a slider to guide light toward the storage media and a near field transducer to focus the light to a spot size smaller than the diffraction limit. While FIG. 1 shows a disc drive, disclosed NFTs can be utilized in other devices that include a near field transducer.

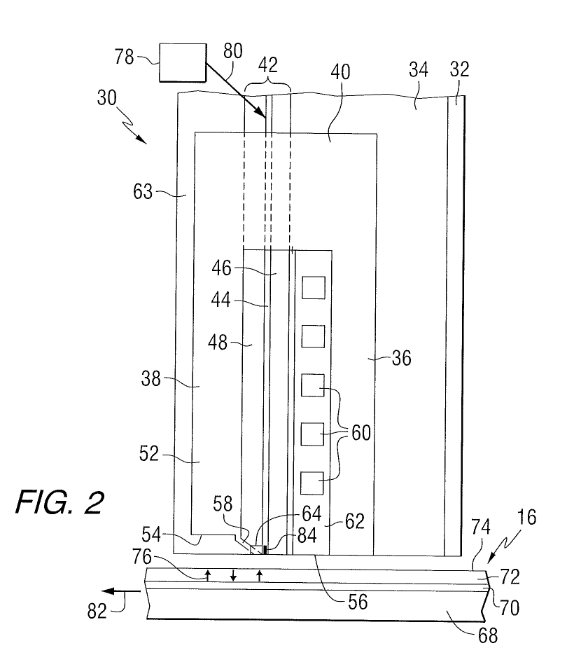

FIG. 2 is a side elevation view of a recording head that may include a disclosed NFT; the recording head is positioned near a storage media. The recording head 30 includes a substrate 32, a base coat 34 on the substrate, a bottom pole 36 on the base coat, and a top pole 38 that is magnetically coupled to the bottom pole through a yoke or pedestal 40. A waveguide 42 is positioned between the top and bottom poles. The waveguide includes a core layer 44 and cladding layers 46 and 48 on opposite sides of the core layer. The top pole is a two-piece pole that includes a first portion, or pole body 52, having a first end 54 that is spaced from the air bearing surface 56, and a second portion, or sloped pole piece 58, extending from the first portion and tilted in a direction toward the NFT. The second portion is structured to include an end adjacent to the air bearing surface 56 of the recording head, with the end being closer to the waveguide than the first portion of the top pole. A planar coil 60 also extends between the top and bottom poles and around the pedestal. In this example, the top pole serves as a write pole and the bottom pole serves as a return pole.

An insulating material 62 separates the coil turns. In one example, the substrate can be AlTiC, the core layer can be Ta₂O₅, and the cladding layers (and other insulating layers) can be Al₂O₃. A top layer of insulating material 63 can be formed on the top pole. A heat sink 64 is positioned adjacent to the sloped pole piece 58. The heat sink can be comprised of a non-magnetic material, such as for example Au.

As illustrated in FIG. 2, the recording head 30 includes a structure for heating the magnetic storage media 16 proximate to where the write pole 58 applies the magnetic write field H to the storage media 16. In this example, the media 16 includes a substrate 68, a heat sink layer 70, a magnetic recording layer 72, and a protective layer 74. However, other types of media, such as bit patterned media can be used. A magnetic field H produced by current in the coil 60 is used to control the direction of magnetization of bits 76 in the recording layer of the media.

The storage media 16 is positioned adjacent to or under the recording head 30. The waveguide 42 conducts light from a source 78 of electromagnetic radiation, which may be, for example, ultraviolet, infrared, or visible light. The source may be, for example, a laser diode, or other suitable laser light source for directing a light beam 80 toward the waveguide 42. Specific exemplary types of light sources 78 can include, for example laser diodes, light emitting diodes (LEDs), edge emitting laser diodes (EELs), vertical cavity surface emitting lasers (VCSELs), and surface emitting diodes. In some embodiments, the light source can produce energy having a wavelength of 830 nm, for example. Various techniques that are known for coupling the light beam 80 into the waveguide 42 may be used. Once the light beam 80 is coupled into the waveguide 42, the light propagates through the waveguide 42 toward a truncated end of the waveguide 42 that is formed adjacent the air bearing surface (ABS) of the recording head 30. Light is focused on the NFT and the energy is transferred from the light to the NFT and subsequently to the media and heats a portion of the media, as the media moves relative to the recording head as shown by arrow 82. A near-field transducer (NFT) 84 is positioned in or adjacent to the waveguide and at or near the air bearing surface. The design may incorporate a heat sink made of a thermally conductive material integral to, or in direct contact with, the NFT 84, and chosen such that it does not prevent coupling of electromagnetic energy into and out of the NFT 84. The heat sink may be composed of a single structure or multiple connected structures, positioned such that they can transfer heat to other metallic features in the head and/or to the gas flow external to the recording head.

Although the example of FIG. 2 shows a perpendicular magnetic recording head and a perpendicular magnetic storage media, it will be appreciated that the disclosure may also be used in conjunction with other types of recording heads and/or storage media as well. It should also be noted that disclosed devices can also be utilized with magnetic recording devices other than HAMR devices.

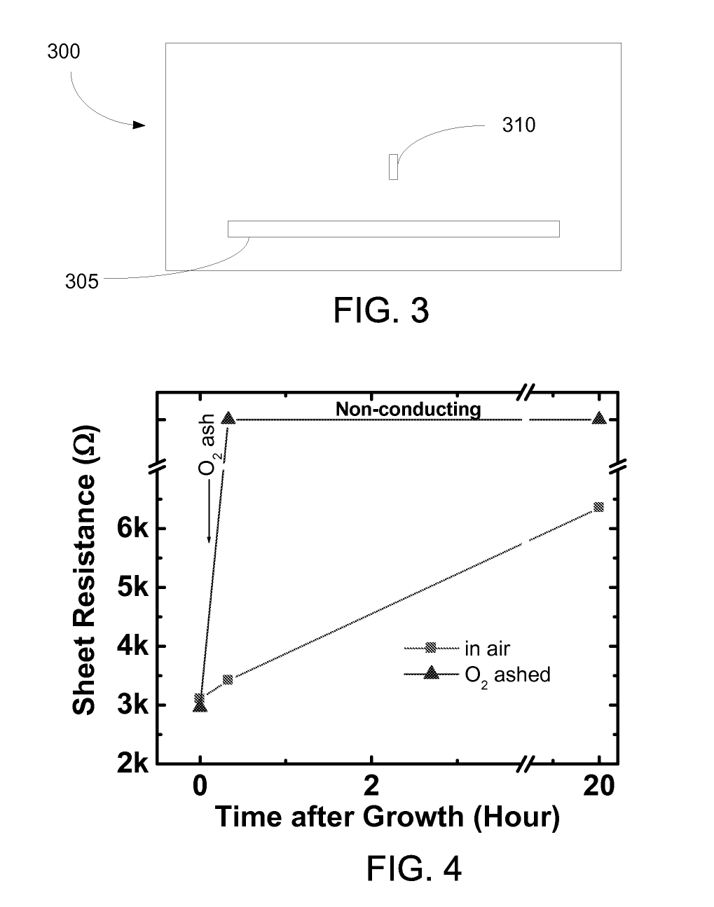

FIG. 3 depicts a view looking down at the air bearing surface (ABS) of a device 300. The device 300 can include a magnetic structure 305 and a magnetic writer 310. The magnetic writer 310 can have details such as those discussed above. The magnetic structure 305 can include a magnetic reader, a return pole, or some combination thereof. In some embodiments, the magnetic writer 310 can also include a NFT, such as those discussed above. The device also includes an overcoat. The overcoat is positioned over at least the magnetic writer. In some embodiments, the overcoat can be positioned over more than just the magnetic writer (i.e., the magnetic reader, the return pole, or both). The overcoat can be a continuous layer, or a non-continuous layer that is positioned over at least a portion of the device on the air bearing surface of the device. In some embodiments, overcoats can also include regions that are continuous as well as non-continuous regions; such overcoats are described herein as non-continuous.

Disclosed overcoats include tantalum oxide. The formula of tantalum oxide or tantalum oxides can be given as Ta_{y}Oₓ with x and y being a number (integer or otherwise). In some embodiments, y can range from 1 or 2; and x can be range from 2 to 5. In some embodiments, y can be 1 or 2; and x can be an integer from 2 to 5. Tantalum oxide exists in various forms, depending on the oxidation state of the tantalum. Tantalum oxide can be described as being tantalum rich (x is higher than y, i.e., fractionally higher) or oxygen rich (y is higher than x, i.e., fractionally higher). Tantalum oxide can also exist as Ta₂O₅, TaO₂, Ta₂O₃, or combinations thereof. The phrase “tantalum oxide”, when used herein can refer to a single form of tantalum oxide or multiple forms of tantalum oxide. Ta₂O₅ can be referred to as tantalum pentoxide, tantalum (V) oxide, or ditantalum pentoxide. TaO₂ can be referred to as tantalum dioxide, or tantalum (IV) oxide. Ta₂O₃ can be referred to as ditantalum trioxide, or a suboxide of tantalum. Disclosed overcoats can also include tantalum in addition to one or more forms of tantalum oxide.

An overcoat that includes tantalum oxide can provide advantages. For example, tantalum oxide can provide beneficial thermal properties that can be advantageous if the device is to be utilized in high temperature environments. In some embodiments where disclosed devices can be used as heat assisted magnetic recording (HAMR) heads, thermal resistance at higher temperatures can be advantageous because HAMR heads generate significant heat during operation. For example, a HAMR head can generate or be utilized in environments where the temperature can be as high as 600° C. Previously utilized overcoats such as DLC (diamond-like carbon) can react with oxygen (in the air at the air-bearing surface (ABS)) at these temperatures and leave the writer un-protected. Tantalum oxides, on the other hand, are very stable, even at these high temperatures and will not leave the writer un-protected. It is desirable to protect the writer because an unprotected writer is likely to corrode (react with water and oxygen) and loose its high-moment magnetic properties, rendering it unable to write magnetic bits. Disclosed overcoats can be less likely to be damaged in such high temperature environments. Tantalum oxide can also provide advantageous long term stability that can be advantageous to offer reliability for long term use of a HAMR head.

Contrary to disclosed overcoats, previously utilized overcoats such as DLC (diamond-like carbon) can react with oxygen (in the air at the air-bearing surface (ABS)) at these temperatures (as high as 500° C.) and leave the writer un-protected. Tantalum oxide is stable, even at these high temperatures, and will not leave the writer un-protected. Protection of the writer can be advantageous because an unprotected writer is likely to corrode (react with water and oxygen) and lose its high-moment magnetic properties, rendering it unable to write magnetic bits.

In some embodiments, disclosed overcoats that include tantalum oxide can have thicknesses from 5 Å to 100 Å. The thickness of the overcoat can be considered a balance between protecting the writer (for example) from the corrosive properties of gasses at the ABS and the performance loss due to the increased writer (and reader) to media spacing. In some disclosed embodiments, overcoats of as little as 10 Å can be deposited, such overcoats may seek to minimize performance loss due to the increased writer to media spacing. In some embodiments, disclosed overcoats can have thicknesses from 5 Å to 60 Å. In some embodiments, disclosed overcoats can have thicknesses from 10 Å to 50 Å. In some embodiments, disclosed overcoats can have thicknesses from 30 Å to 50 Å, or in some embodiments 40 Å.

Also disclosed herein are methods of forming articles. Disclosed methods can generally include a step of forming a layer of tantalum oxide on a structure. In some embodiments, the structure upon which the tantalum oxide layer is to be formed can include a magnetic structure. In some embodiments, the magnetic structure can include a magnetic writer. Details of magnetic writers were discussed above. In some embodiments, the magnetic structure can also include a near field transducer (NFT), additional structures for use in HAMR, or some combination thereof. Magnetic structures upon which disclosed overcoat layers are formed can be formed prior to disclosed methods being carried out by the same user or another. Subsequent steps can be included between the formation of the magnetic structure and the overcoat layer. For example, a magnetic structure can be formed on a wafer, the wafer can be cut into bars (including one or more magnetic structures), and the bars can be processed to form heads. Such processing can include steps that are designed to form the ABS (see air bearing surface 56 in FIG. 2), for example such processing can include lapping steps. The ABS (for example after a bar has been lapped) can be referred to herein as forming the second opposing surface of the magnetic structure. One step in some disclosed methods can include forming a tantalum oxide layer on at least a portion of the ABS.

In some embodiments, a tantalum oxide layer can be formed by depositing tantalum (Ta) in an oxygen atmosphere. In some embodiments, “an oxygen atmosphere” refers to a partial pressure of oxygen of approximately 5 mTorr. The Ta can be deposited by sputtering, or physical vapor deposition for example. Deposition of Ta in an oxygen atmosphere can automatically oxidize the Ta as it is being deposited. In some embodiments, a portion of Ta can be deposited in a non-oxygen atmosphere and then another portion of Ta can be deposited in an oxygen atmosphere. Such methods that include an initial step of a non-oxygen atmosphere could be advantageous because it would minimize or eliminate exposure of the magnetic structure (or portions thereof) to an oxygen atmosphere. Some materials present in magnetic structures can be detrimentally affected by an oxygen atmosphere. Such methods could provide an article that has a magnetic structure, at least a partial layer of tantalum, and at least a partial layer of tantalum oxide. In some embodiments, TaₓO_{y} can be created by RF sputtering from a TaₓO_{y} target. In some embodiments, TaₓO_{y} can be created by reactive deposition from a Ta target in an oxygen environment (for example sputtering, evaporation, etc.). In some embodiments, TaₓO_{y} can be created by depositing metallic tantalum and then oxidizing it.

In some embodiments, a tantalum oxide layer can be formed by depositing a Ta layer and then subsequently oxidizing at least a part of the Ta layer. The Ta can be deposited for example by sputtering, or physical vapor deposition. The step of oxidizing the deposited Ta can be accomplished, for example, using plasma ashing using oxygen, radical shower, plasma oxidation, O₂ exposure, or some combination thereof for example. In some embodiments, the oxidation step can also be combined with a high temperature environment in order to enhance the oxidation (e.g., annealing in an oven, baking with a hot plate, etc.). Plasma ashing using oxygen creates a monoatomic oxygen plasma by exposing oxygen gas at a low pressure to high power radio waves, which ionize it.

In some embodiments, a layer of Ta that is less thick than the desired tantalum oxide layer can be deposited. Once the tantalum layer is oxidized, the final layer will have a thickness that is increased from the original tantalum layer. In some embodiments, the thickness can increase at least 30%, and in some embodiments, the thickness can increase 30% to 40%. In some embodiments, lower power tantalum deposition can help more accurately control the thickness of the final tantalum oxide layer. In some embodiments, lower tantalum deposition at not greater than 300 W can be utilized, and in some embodiments, tantalum deposition at not greater than 200 W can be utilized.

In some embodiments, not all of the Ta need be oxidized. Such methods could be advantageous because it would minimize or eliminate exposure of the magnetic structure (or portions thereof) to an oxygen atmosphere or an oxidized material. Some materials present in magnetic structures can be detrimentally affected by an oxygen atmosphere or oxidized material. Such methods could provide an article that has a magnetic structure, at least a partial layer of tantalum, and at least a partial layer of tantalum oxide.

A sheet of tantalum (14 Å) was deposited using DC magnetron sputtering from a tantalum target. FIG. 4 demonstrates that a thin layer of Ta can be fully oxidized using the oxygen ashing method. The electrical sheet resistance of (Ω/square) tantalum after deposition (growth) of the tantalum for a tantalum sheet in air and a tantalum sheet that is oxygen ashed are shown. As seen there, oxygen ashing effectively changes the tantalum into an insulator, whereas a tantalum sheet exposed to air oxidizes very slowly.

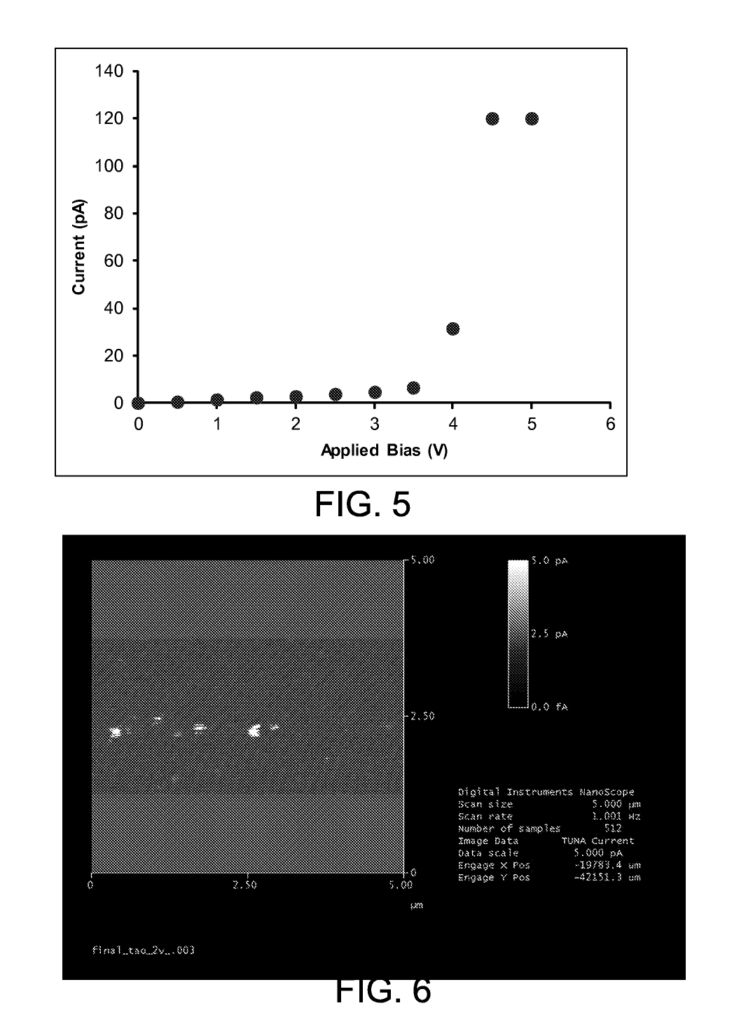

FIG. 5 shows a plot of current (pA) versus applied bias (V) for oxygen ashed tantalum gathered from a Tunneling Atomic Force Microscope (TUNA) measurements. This shows little leakage current with the application of a bias voltage up to 3.5V, which yields a dielectric breakdown field being larger than 10 MV/cm. This indicates that the oxidation of the Ta was complete and the resultant TaₓO_{y} had good dielectric behavior. FIG. 6 is a mapping of the leakage current under a 2V bias within a 5 um×5 um region. It shows that the oxidation of Ta was uniform across the film.

Thus, embodiments of magnetic devices including overcoat layers are disclosed. The implementations described above and other implementations are within the scope of the following claims. One skilled in the art will appreciate that the present disclosure can be practiced with embodiments other than those disclosed. The disclosed embodiments are presented for purposes of illustration and not limitation.

What is claimed is:

1. A magnetic device comprising:
a magnetic writer; and
an overcoat positioned over at least the magnetic writer, the overcoat comprising tantalum oxide (Ta_{y}Oₓ), where y ranges from about 1 to 2 and x ranges from about 2 to 5, or mixtures thereof.

2. The magnetic device according to claim 1, wherein the overcoat has a thickness from about 5 Å to about 100 Å.

3. The magnetic device according to claim 1, wherein the overcoat has a thickness from about 10 Å to about 50 Å.

4. The magnetic device according to claim 1, wherein the overcoat has a thickness from about 30 Å to about 50 Å.

5. The magnetic device according to claim 1, wherein the Ta_{y}Oₓ comprises Ta₂O₅.

6. The magnetic device according to claim 1, wherein the Ta_{y}Oₓ comprises TaO₂.

7. The magnetic device according to claim 1, wherein the Ta_{y}Oₓ comprises Ta₂O₃.

8. The magnetic device according to claim 1 further comprising a near field transducer (NFT).

9. A method of forming an article, the method comprising:
forming a magnetic structure on a substrate, the magnetic structure having a first surface adjacent the substrate and a second opposing surface; and
forming a tantalum oxide layer on the second surface of at least the magnetic structure.

10. The method according to claim 9, wherein the tantalum oxide layer comprises tantalum oxide and tantalum.

11. The method according to claim 9, wherein forming a tantalum oxide layer comprises depositing tantalum in an oxygen rich environment.

12. The method according to claim 9, wherein forming a tantalum oxide layer comprises depositing a tantalum layer and oxidizing at least a portion of the tantalum layer.

13. The method according to claim 9, wherein the tantalum oxide layer has a thickness from about 5 Å to about 100 Å.

14. The method according to claim 9, wherein the tantalum oxide layer has a thickness from about 30 Å to about 50 Å.

15. The method according to claim 9, wherein the tantalum oxide layer comprises Ta₂O₅, TaO₂, Ta₂O₃, Ta, or combinations thereof.

16. A method of forming an article, the method comprising:
forming a magnetic structure on a substrate;
forming a tantalum layer on at least the magnetic structure; and
oxidizing at least a portion of the tantalum layer to form a tantalum oxide layer.

17. The method according to claim 16, wherein a portion of the tantalum layer adjacent the magnetic structure is not oxidized.

18. The method according to claim 16, wherein the tantalum oxide layer has a thickness from about 5 Å to about 100 Å.

19. The method according to claim 18, wherein the tantalum layer formed on at least the magnetic structure has a thickness that is at least about 30% less than the tantalum oxide layer.

20. The method according to claim 16, wherein the tantalum oxide layer comprises Ta₂O₅, TaO₂, Ta₂O₃, Ta, or combinations thereof.
